(19) United States
(12) Patent Application Publication
(10) Pub. No.: US 2021/0112025 A1
(43) Pub. Date: Apr. 15, 2021

(54) METHOD AND SERVER FOR PROCESSING MESSAGES

(71) Applicant: BEIJING DAJIA INTERNET INFORMATION TECHNOLOGY CO., LTD., Beijing (CN)

(72) Inventor: Shuo LIU, Beijing (CN)

(21) Appl. No.: 17/130,373

(22) Filed: Dec. 22, 2020

Related U.S. Application Data
(63) Continuation of application No. PCT/CN2018/123957, filed on Dec. 26, 2018.

(30) Foreign Application Priority Data
Jun. 22, 2018 (CN) 201810652867.3

(51) Int. Cl. H04L 12/58

(52) U.S. Cl. CPC H04L 51/12; H04L 51/14; H04L 51/26; H04L 51/06

(57) ABSTRACT

A method for processing messages can include: detecting a user input operation, and determining a second client, whose messages are to be deleted, in a target group; sending a delete request to a server, wherein the delete request includes an ID of the target group and an ID of the second client, and the server is configured to acquire an ID of a target message based on the delete request and send a delete instruction to a third client, the third client is configured to delete the target message based on the delete instruction, and the delete instruction includes the ID of the target message; wherein the target message is sent by the second client in the target group, and the first client, the second client, and the third client belong to the target group.

### CROSS-REFERENCE TO RELATED APPLICATIONS

This application is a continuation application of international application No. PCT/CN2018/123957, filed on Dec. 26, 2018 and entitled “MESSAGE PROCESSING METHOD AND DEVICE”, which claims priority to Chinese Patent Application No. 201810652867.3, filed on Jun. 22, 2018 and entitled “METHOD AND APPARATUS FOR PROCESSING MESSAGES”, the disclosure of each of which is incorporated herein by reference in its entirety.

### TECHNICAL FIELD

The present disclosure relates to a technical field of network, and in particular, relates to a method and a server for processing messages.

### BACKGROUND

With the continuous development of computer technologies, mobile terminals are more and more widely used. Users often send messages for chatting by an instant messaging (IM) client on a mobile terminal. For example, different users may add their own clients to a same group and chat with many people.

In practical applications, unauthorized users may maliciously send negative or bad messages in the group by their own clients, for example, sending messages containing violent factors. In order to avoid the influence of negative messages, users corresponding to other clients in the group usually need to select these negative messages and then manually delete these negative messages by a delete option. However, these operations are complex, and are quite less convenient.

### SUMMARY

The present disclosure provides a method and a server for processing messages.

According to one aspect of the present disclosure, a method for processing messages is provided. The method is applicable to a first client. The method includes: determining a second client in a target group based on a user input operation, wherein the second client has sent a target message to be deleted in the target group; and sending a delete request to a server, wherein the delete request includes an identification (ID) of the target group and an ID of the second client, and the server is configured to acquire an ID of the target message based on the delete request and send a delete instruction to a third client, the third client is configured to delete the target message based on the delete instruction, and the delete instruction includes the ID of the target message; wherein the first client, the second client, and the third client belong to the target group.

According to another aspect of the present disclosure, another method for processing messages is provided. The method is applicable to a server. The method includes: receiving a delete request from a first client, wherein the delete request is sent by the first client upon determining a second client, whose messages are to be deleted, in a target group, the second client is determined by the first client based on a detected user input operation; acquiring an ID of a target message based on the delete request, wherein the target message is sent by the second client in the target group; and sending a delete instruction to a third client, wherein the third client is configured to delete the target message based on the delete instruction; wherein the delete request includes an ID of the target group and an ID of the second client, the delete instruction includes the ID of the target message, and the first client, the second client, and the third client belong to the target group.

According to another aspect of the present disclosure, a mobile terminal is provided. The mobile terminal includes: a processor, a memory, and a message processing program that is stored in the memory and runnable on the processor, wherein the message processing program, when run by the processor, causes the processor to perform a method including: determining a second client in a target group based on a user input operation, wherein the second client has sent a target message to be deleted in the target group; and sending a delete request to a server, wherein the delete request includes an ID of the target group and an ID of the second client, and the server is configured to acquire an ID of the target message based on the delete request and send a delete instruction to a third client, the third client is configured to delete the target message based on the delete instruction, and the delete instruction includes the ID of the target message; wherein the first client, the second client, and the third client belong to the target group.

According to another aspect of the present disclosure, a computer-readable storage medium storing a message processing program is provided. The message processing program, when run by a processor, causes the processor to a method including: determining a second client in a target group based on the user input operation based on a user input operation, wherein the second client has sent a target message to be deleted in the target group; and sending a delete request to a server, wherein the delete request includes an ID of the target group and an ID of the second client, and the server is configured to acquire an ID of the target message based on the delete request and send a delete instruction to a third client, the third client is configured to delete the target message based on the delete instruction, and the delete instruction includes the ID of the target message; wherein the first client, the second client, and the third client belong to the target group.

According to another aspect of the present disclosure, a server is provided. The server includes: a processor, a memory, and a message processing program that is stored in the memory and runnable on the processor, wherein the message processing program, when run by the processor, causes the processor to perform a method including: receiving a delete request from a first client, wherein the delete request is sent by the first client upon determining a second client, whose messages are to be deleted, in a target group, and the second client is determined by the first client based on a detected user input operation; acquiring an ID of a target message based on the delete request, wherein the target message is sent by the second client in the target group; and sending a delete instruction to a third client, wherein the third client is configured to delete the target message based on the delete instruction; wherein the delete request includes an ID of the target group and an ID of the second client, the delete instruction includes the ID of the target message, and the first client, the second client, and the third client belong to the target group.

According to another aspect of the present disclosure, a computer-readable storage medium storing a message processing program is provided. The message processing program, when run by a processor, causes the processor to perform a method including: receiving a delete request from a first client, wherein the delete request is sent by the first client upon determining a second client, whose messages are to be deleted, in a target group, and the second client is determined by the first client based on a detected user input operation; acquiring an ID of a target message based on the delete request, wherein the target message is sent by the second client in the target group; and sending a delete instruction to a third client, wherein the third client is configured to delete the target message based on the delete instruction; wherein the delete request includes an ID of the target group and an ID of the second client, the delete instruction includes the ID of the target message, and the first client, the second client, and the third client belong to the target group.

According to another aspect of the present disclosure, a computer program product storing at least one computer program including at least one instruction is provided. The instruction, when executed by a processor, causes the processor to perform a method including: determining a second client in a target group based on a user input operation, wherein the second client has sent a target message to be deleted in the target group; and sending a delete request to a server, wherein the delete request includes an ID of the target group and an ID of the second client, and the server is configured to acquire an ID of the target message based on the delete request and send a delete instruction to a third client, the third client is configured to delete the target message based on the delete instruction, and the delete instruction includes the ID of the target message; wherein the first client, the second client, and the third client belong to the target group.

According to another aspect of the present disclosure, a computer program product storing a computer program including at least one instruction is provided. The at least one instruction, when executed by a processor, causes the processor to perform a method including: receiving a delete request from a first client, wherein the delete request is sent by the first client upon determining a second client, whose messages are to be deleted, in a target group, wherein the second client is determined by the first client based on a detected user input operation; acquiring an ID of a target message based on the delete request, wherein the target message is sent by the second client in the target group; and sending a delete instruction to a third client, wherein the third client is configured to delete the target message based on the delete instruction; wherein the delete request includes an ID of the target group and an ID of the second client, the delete instruction includes the ID of the target message, and the first client, the second client, and the third client belong to the target group.

### BRIEF DESCRIPTION OF THE DRAWINGS

Accompanying drawings are only illustrative purposes of the optional embodiments, and not intended to limit the present disclosure. In the whole accompanying drawings, similar reference signs denote similar elements. In the drawings:

FIG. 1 is a schematic structural diagram of an implementation environment according to an embodiments of the present disclosure;

FIG. 2 is a flowchart of steps of a method for processing messages according to an embodiment of the present disclosure;

FIG. 3 is a flowchart of steps of another method for processing messages according to an embodiment of the disclosure;

FIG. 4 is a flowchart of steps of yet another method for processing messages according to an embodiment of the present disclosure;

FIG. 5 is a block diagram of an apparatus for processing messages according to an embodiment of the present disclosure; and

FIG. 6 is a block diagram of another apparatus for processing messages according to an embodiment of the present disclosure.

### DETAILED DESCRIPTION

The example embodiments of the present disclosure will be described in detail hereinafter with reference to the drawings. Although the example embodiments of the present disclosure are shown in the accompanying drawings, it should be understood that the present disclosure may be realized in various forms and shall not be limited to the embodiments elaborated herein. On the contrary, these example embodiments are described only for thorough understanding of the present disclosure, and the scope of the present disclosure can be completely conveyed to a person skilled in the art.

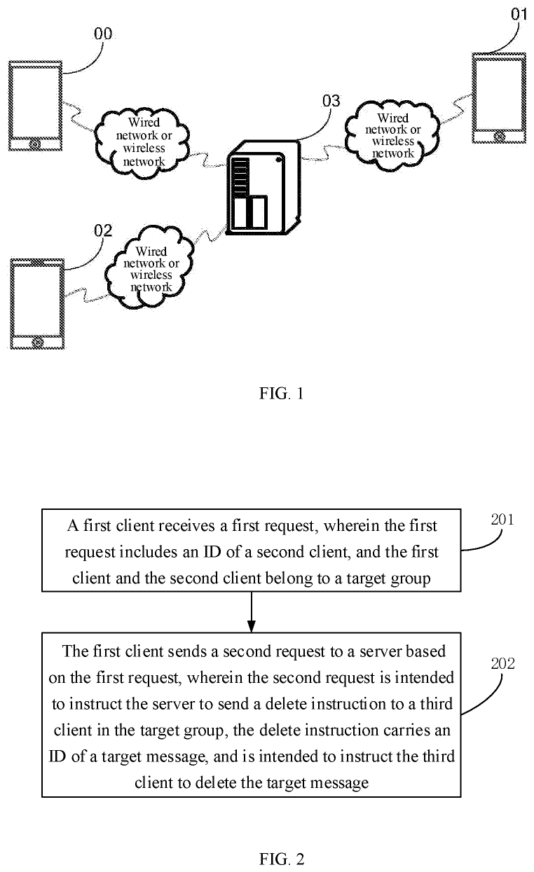

FIG. 1 is a schematic structural diagram of an implementation environment according to an embodiment of the present disclosure. The implementation environment involves a first terminal 00, a second terminal 01, a third terminal 02, and a server 03.

A social networking client runs in all of the first terminal 00, the second terminal 01 and the third terminal 02, where a first client of the social networking client runs in the first terminal 00, a second client of the social networking client runs in the second terminal 01, and a third client of the social networking client runs in the third terminal 02.

In some embodiments, the first terminal 00, the second terminal 01 and the third terminal 02 may be a mobile phone, a tablet personal computer, an e-book reader, a laptop computer or a desktop computer and the like. The server 03 may be a server, or a server cluster including a plurality of servers, or a cloud computing service center.

In some embodiments, the first terminal 00, the second terminal 01, and the third terminal 02 are all be connected to the server 03 by a wireless network or a wired network.

According to the embodiment of the present disclosure, when a negative message appears at a target group, the negative message may be actively deleted. Specifically, the first client detects a user input operation, and determines the second client in the target group, whose messages are to be deleted, based on the user input operation. Afterwards, a delete request is sent to the server, where the delete request includes an ID (identification) of the target group and an ID of the second client. The server is configured to acquire an ID of a target message based on the delete request, and send a delete instruction to the third client. The third client is configured to delete the target message based on the delete request. The delete instruction includes the ID of the target message. The target message is sent by the second client in the target group, and the first client, the second client, and the third client belong to the target group. That is, upon receiving the delete request from the first client, the server may acquire the ID of the target message sent by the second client in the target group based on the delete request, and sends the delete instruction to the third client in the target group. In some embodiments, the target message is the negative message as described above. In addition, the server may also delete a stored target message, and add a placeholder message at a storage position of the deleted target message.

Referring to FIG. 2, which is a flowchart of steps of a method for processing messages according to an embodiment of the present disclosure. Illustration is made in the embodiment by applying the method for processing messages to the first client running in the first terminal in the implementation environment shown in FIG. 1. As shown in FIG. 2, the method may include the following steps:

In 201, the first client receives a first request. The first request includes an ID of a second client. The first client and the second client belong to a target group.

In some embodiments, the first request is generated by a user by triggering the first terminal. For example, the user generates the first request by triggering a first message delete function of the first terminal.

In some embodiments, the first message delete function is triggered by an option, and the first client displays a client interface. Upon detecting an operation of the user on the target group in the client interface, the first client receives the first request, and determines a second client to be processed in the target group. For example, the first terminal displays one first message delete option on a notification bar. It is assumed that when the second client sends a negative message in the target group, the user is capable of generating the first request by triggering the first message delete option when the user desires to delete the negative message sent by the second client in the target group. Nevertheless, the first message delete function may also be triggered in other ways, which is not limited in the embodiment of the present disclosure.

By this step, the first client detects a user input operation, and determines the second client in the target group, whose messages are to be deleted, based on the user input operations.

In 202, the first client sends a second request to a server based on the first request. The second request is intended to instruct the server to send a delete instruction to a third client in the target group. The delete instruction carries an ID of a target message, and is intended to instruct the third client to delete the target message.

The number of target messages may be one or more.

In some embodiments, the second request includes an ID of the target group and an ID of the second client. In this way, the server is capable of determining to delete the message sends from the client in the group according to the received second request.

In some embodiments, the third clients are part of clients included in the target group, or may also be all clients included in the target group. Accordingly, the server sends a delete instruction carrying the ID of the target message to the part of clients in the target group, such that the part of clients in the target group are capable of actively deleting the previously-received message from the second client.

In some embodiments, the server is also capable of sending the delete instruction to all the clients in the target group, such that all the clients in the target group are capable of actively deleting the message previously-received from the second client. In this way, the user does not need to manually delete the message previously-received from the second client.

In conclusion, the method for processing the message according to the embodiments of the disclosure can simplify the deletion of the message and improve the deletion efficiency.

In some embodiments, the third clients receiving the delete instruction may include the first client and/or the second client, and may also not include the first client and/or the second client, which is not limited in the embodiment of the present disclosure. The first client and/or the second client may be interpreted as the first client, the second client, or the first client and the second client.

It should be noted that the second request is also referred to as the delete request. By this step, the first client sends the delete request to the server, wherein the delete request includes the ID of the target group and the ID of the second client. The server is configured to acquire the ID of the target message based on the delete request and sends the delete instruction to the third client. The third client is configured to delete the target message based on the delete request. The delete instruction includes the ID of the target message.

In conclusion, the method for processing the message according to the embodiments of the disclosure can simplify the deletion of the message and improve the deletion efficiency.

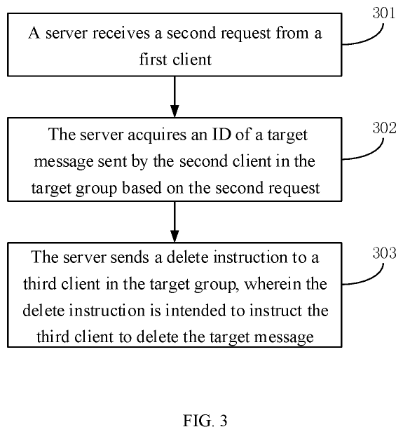

Referring to FIG. 3, which is a flowchart of steps of another method for processing messages according to an embodiment of the present disclosure. Illustration is made in the embodiment by applying the method for processing messages to a server in the implementation environment shown in FIG. 1. As shown in FIG. 3, the method includes the following steps:

In 301, the server receives a second request from a first client.

In some embodiments, the second request at least includes an ID of a target group and an ID of the second client. The target group is a group including the first client and the second client.

In 302, the server acquires, based on the second request, an ID of a target message sent by the second client in the target group.

In some embodiments, the server first analyzes the second request, extracts the ID of the second client and the ID of the target group from the analyzed second request and then acquires the ID of the target message sent by the second client in the target group by searching in stored history data based on the ID of the second client and the ID of the target group.

In some embodiments, the target message is part of messages sent by the second client in the target group or all the messages, which is not limited in the embodiment of the present disclosure.

In 303, the server sends a delete instruction to a third client in the target group. The delete instruction is intended to instruct the third client to delete the target message.

In some embodiments, the delete instruction includes the ID of the target message, such that the third client deletes the corresponding target message. Further, the third client corresponds to the third terminal in the implementation environment shown in FIG. 1. It should be noted that FIG. 1 schematically shows one third terminal. In practice, the number of third terminals included in the implementation environment corresponds to the number of third clients.

In conclusion, the method for processing the message according to the embodiments of the disclosure can simplify the deletion of the message and improve the deletion efficiency.

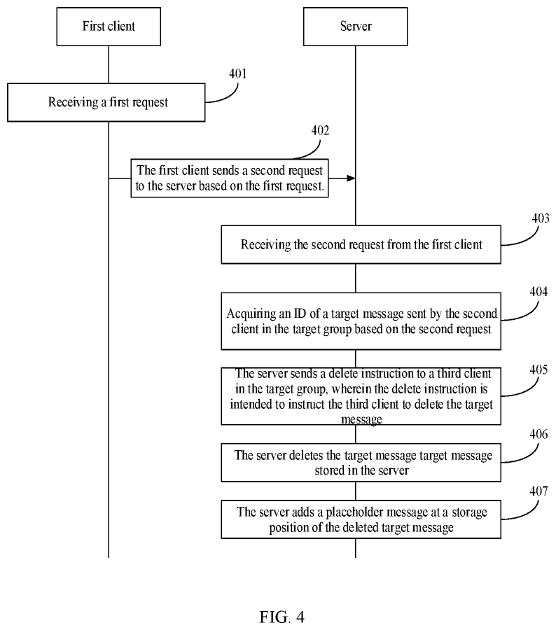

Referring to FIG. 4, which is a flowchart of steps of yet another method for processing messages according to an embodiment of the present disclosure. As shown in FIG. 4, the method may include the following steps:

In 401, a first client receives a first request.

In some embodiments, the first request at least includes an ID of a second client belonging to a target group.

In some embodiments, in order to prevent the second client from continuing to send a negative message in the target group, a user first triggers, by a trigger operation, a first terminal to generate a remove instruction. The remove instruction is intended to instruct the first client to remove the second client from the target group to as much as possible reduce impacts caused by the negative message sent by the second client on the other clients in the target group.

In some embodiments, the first client may send a remove request to a server upon receiving the remove instruction, and the server may verify whether the first client has a remove authority or not. In some embodiments, the remove authority is an administrator authority. The second client is removed from the target group based on the remove request when the first client has the remove authority. Accordingly, after the second client is removed, the first client displays a message delete option. The message delete option is configured determine, from the user, whether the message sent by the second client is deleted or not. The user triggers the first terminal to generate the first request by selecting the message delete option.

In 402, the first client sends a second request to the server based on the first request.

In some embodiments, the second request may at least include an ID of the target group and an ID of the second client, and accordingly, the first client adds the ID of the target group to the first request to obtain the second request, and then send the second request to the server.

Furthermore, since the second client may sends a negative message in the target group only at a specific time period, the second request also includes a delete time period to instruct the server to only determine a message sent by the second client in the target group within the delete time period as a target message. In some embodiments, the first client further displays at least one time period option before sending the second request to the server and different time period options correspond to different time periods. Then, a time period corresponding to the time period selected by the user is determined as the delete time period, if a select operation of the user on any one time period option is detected. Meanwhile, in order to avoid maliciously deleting messages sent by client members in the target group, the second request may also include an ID of the first client, such that the server judges whether a client requesting to delete the message sent by the second client has a delete authority or not.

Accordingly, the first terminal sends the second request to the server by 4021 and 4022.

In 4021, the first client obtains the second request by adding the ID of the target group, the ID of the first client, and the delete time period to the first request.

In some embodiments, the first client obtains the second request by inserting the ID of the target group, the ID of the first client, and the delete time period to preset positions of the first request.

In 4022, the first client sends the second request to the server.

In 403, the server receives the second request from the first client.

For details of this step, reference may be made to step 201, which are not elaborated herein.

In 404, the server acquires an ID of the target message sent by the second client in the target group based on the second request.

In some embodiments, the second request also includes the ID of the first client and the delete time period. Accordingly, the server may acquire the ID of the target message sent by the second client in the target group by 4041 and 4042.

In 4041, the server extracts the ID of the first client and the ID of the target group in the second request, and determines, based on the ID of the first client and the ID of the target group, whether the first client has the delete authority or not.

In some embodiments, the server first analyzes the second request, and then extracts the ID of the first client and the ID of the target group in the analyzed second request. Furthermore, the server stores a plurality of groups, wherein different groups includes different clients In some embodiments, the server first determines an authority list corresponding to the target group based on the ID of the target group, and then determines whether the authority list corresponding to the target group includes the ID of the first client or not. If the authority list includes the ID of the first client, the server determines that the first client has the delete authority; and otherwise, the server determines that the first client does not have the delete authority.

In 4042, the server extracts the delete time period in the second request if the first client has the delete authority.

In some embodiments, the server extracts the delete time period from the analyzed second request.

In 4043, the server determines a message sent by the second client in the target group within the delete time period as the target message based on the ID of the second client and the ID of the target group, and acquires the ID of each target message.

In some embodiments, since the second client may participate in a plurality of groups, such that the server determines the target group based on the ID of the target group. In some embodiments, the server compares the ID of the target group in the second request with a stored ID of each of the groups and determine a group matched with the ID of the target group as the target group. In some embodiments, it is assumed that the second client participates in a group A, a group B and a group C, and the ID of the target group is matched with an ID of the group B, then the group B is determined as the target group.

Furthermore, the message sent by the client may include the ID of the client, and thus the server first acquires a message to obtain a target message, and the message is in a message set corresponds to the target group and carries the ID of the second client and has sending time within a preset time period. The message set corresponding to the target group includes messages sent by each of the clients in the target group. In addition, the server extracts the ID of the target message by analyzing the target message.

In 405, the server sends a delete instruction to a third client in the target group. The delete instruction is intended to instruct the third client to delete the target message.

In some embodiments, the delete instruction indicates an erase-type message event. A content field of the message event stores the ID of the target message, and the message event is a push event. In some embodiments, the server sends the delete instruction to the third client in the target group by broadcasting the message event to the third client in the target message.

Accordingly, any one of the third clients deletes the stored target message by 4052 and 4052.

In 4051, the third client receives the delete instruction from the server.

The delete instruction at least includes the ID of the target message.

In 4052, the third client deletes the target message corresponding to the ID of the target message based on the delete instruction.

In the step, the target message is a message previously received by the third client and sent by the second client in the target group. In some embodiments, the third client extracts the target message ID from the delete instruction and then deletes the message indicated by the ID of the target message.

It should be noted that other information, such as the ID of the second client, is also included in the content field of the message event. In this way, when deleting the target message, the third client may also determine whether, the target message to be deleted is the message sent by the second client or not, thereby preventing mis-deletion of messages.

In 406, the server deletes each target message stored in the server.

In some embodiments, storage space may be saved by deleting the target message, thereby to ensuring sufficient storing space in the server.

In 407, the server adds a placeholder message at a storage position of the deleted target message.

In practice, the client may sequentially assign a sequence number to each of messages received, and sequentially store, based on the sequence number, each of the messages in a form of a message chain. After each of the third clients deletes the target message based on the delete instruction, sequence number discontinuity and message incompleteness may be caused. In this case, the third client may consider that part of messages are not received, and further acquire messages from the server based on the ID of the message corresponding to missing sequence numbers to complete the message chain.

In the embodiment of the present disclosure, since the server has deleted the target message, the server needs to generate a message indicated by the ID of the deleted target message and returns the message to the client, such that the third client complete the messages in the message chain. In the embodiment of the present disclosure, the above problem is solved by adding a placeholder message to the storage position of the target message. In some embodiments, the ID of the set placeholder message is the same as the ID of the deleted target message so that the corresponding placeholder message is directly returned to the third client by the server without regenerating the message when the third client requires the server to refresh the message. In this way, the third client can be avoided from being affected by the negative message again as well as the third client completes the message chain, and unnecessary generation operation of the server is avoided. The placeholder message is a message with empty content, and the format of the placeholder message is different from that of a normal message.

In some other embodiments, after deleting the target message based on the delete instruction, the third client a is further capable of actively adding the placeholder message at the storage position of the target message to ensure continuity of the sequence numbers of the messages and completeness of the message chain, thereby avoiding the problem of requesting a server for a message caused by message chain incompleteness and reducing operation steps. In addition, the server also does not need to execute the step of adding the placeholder message to the storage position of the deleted target message, thereby further reducing the operation step and saving implementation cost.

In conclusion, according to the method for processing the message according to the embodiment of the present disclosure, the first client first receives the first request and then sends the second request to the server according to the first request. The first request includes the ID of the second client, and both the first client and the second client belong to the target group. The second request includes the ID of the target group and the ID of the second client. After receiving the second request, the server acquires the ID of the target message sent by the second client in the target group according to the second request, and sends the delete instruction to at least two third clients in the target group to instruct each of the third clients so as to delete the target message corresponding to each target message ID according to the delete instruction. Finally, the server deletes each stored target message and add the placeholder message to the storage position of the deleted target message. In this way, when a negative message appears in the target group, operations of other users conducting deletion manually can be reduced, and the server can cause the third client to actively delete the received negative message based on a second request sent by the first client.

In conclusion, the method for processing the message according to the embodiments of the disclosure can simplify the deletion of the message and improve the deletion efficiency.

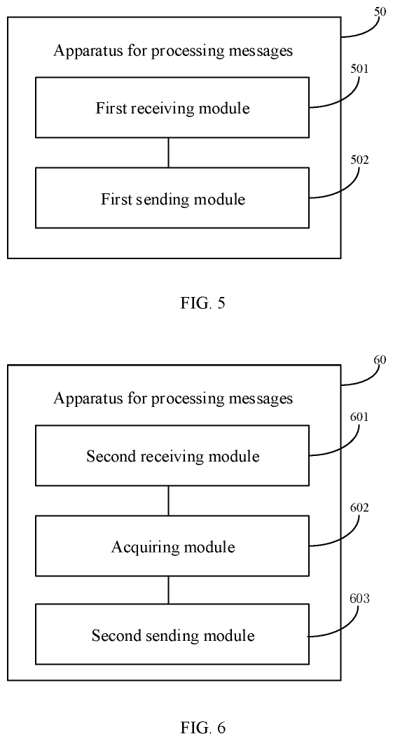

Referring to FIG. 5, which is a block diagram of an apparatus 50 for processing messages according to an embodiment of the present disclosure. The apparatus 50 is applicable to a first client. As shown in FIG. 5, the apparatus 50 includes:

a first receiving module 501, configured to detect a user input operation, and determine a second client, whose messages are to be deleted, in a target group; and

a first sending module 502, configured to send a delete request to a server, wherein the delete request includes an ID of the target group and an ID of the second client, and the server is configured to acquire an ID of a target message based on the delete request and send a delete instruction to a third client, the third client is configured to delete the target message based on the delete instruction, and the deletion instruction includes the ID of the target messages;

wherein the target message is sent by the second client in the target group, and the first client, the second client, and the third client belong to the target group.

In conclusion, the apparatus for processing the message according to the embodiment of the present disclosure can simplify the deletion of the message and improve the deletion efficiency.

In some embodiments, the apparatus 50 further includes:

a displaying module configured to display at least one time period option, wherein different time period options correspond to different time periods; and

a determining module configured to determine a time period corresponding to a selected time period option as a delete time period, in response to detecting an operation of selecting any of the at least one time period option, wherein the target message is sent by the second client within the delete time period.

In some embodiments, the delete request further includes a delete time period and an ID of the first client.

In some embodiments, the delete request is intended to instruct the server to:

extract the ID of the first client and the ID of the target group from the delete request;

in response to the ID of the first client and the ID of the target group, determine that the first client has a delete authority, and extract the delete time period from the delete request; and

determine, based on the ID of the second client and the ID of the target group, a message sent by the second client in the target group within the delete time period as the target message, and acquire the ID of the target message.

In some embodiments, the delete instruction indicates an erase-type message event, and the ID of the target message is stored in a content field of the message event; and

the delete instruction is broadcast to the third client in the target group.

In some embodiments, the delete request is intended to instruct the server to delete the target message stored in the server.

In some embodiments, the delete request is intended to instruct the server to add a placeholder message at a storage position of the target message; wherein an ID of the placeholder message is the same as the ID of the target message.

Referring to FIG. 6, which is a block diagram of another apparatus 60 for processing messages according to an embodiment of the present disclosure. The apparatus 60 is applicable to a server. As shown in FIG. 6, the apparatus 60 includes:

a second receiving module 601, configured to receive a delete request from a first client, wherein the delete request is sent by the first client upon determining a second client in a target group, and the second client is determined by the first client based on a detected user input operation;

an acquiring module 602, configured to acquire an ID of a target message based on the delete request, wherein the target message is sent by the second client in the target group; and

a second sending module 603, configured to send a delete instruction to a third client, wherein the third client is configured to delete the target message based on the delete instruction;

the delete request includes an ID of the target group and an ID of the second client, the delete instruction includes the ID of the target message, and the first client, the second client, and the third client belong to the target group.

In conclusion, the apparatus for processing the message according to the embodiment of the present disclosure can simplify the deletion of the message and improve the deletion efficiency.

In some embodiments, the delete request further includes a delete time period and an ID of the first client

In some embodiments, the delete time period is determined by the first client by:

displaying at least one time period option, wherein different time period options correspond to different time periods; and

in response to detecting an operation of selecting any of the at least one time period option, determining a time period corresponding to a selected time period option as a delete time period;

wherein the target message is sent by the second client within the delete time period.

In some embodiments, the acquiring module 602 is further configured to:

extract the ID of the first client and the ID of the target group from the delete request;

in response to the ID of the first client and the ID of the target group, determine that the first client has a delete authority, and extract the delete time period from the delete request; and

determine, based on the ID of the second client and the ID of the target group, a message sent by the second client in the target group within the delete time period as the target message, and acquire the ID of the target message.

In some embodiments, the delete instruction indicates an erase-type message event, and the ID of the target message is stored in a content field of the message event.

Accordingly, the second sending module 603 is further configured to broadcast the delete instruction to the third client in the target group.

In some embodiments, the apparatus 60 further includes:

a deleting module, configured to delete the target message stored in the server.

In some embodiments, the apparatus 60 further includes:

an adding module, configured to add a placeholder message at a storage position of the target message; wherein an ID of the placeholder message is the same as the ID of the target message.

According to an embodiment of the present disclosure, a mobile terminal is provided. The mobile terminal includes: a processor, a memory, and a message processing program that is stored in the memory and runnable on the processor. The message processing program, when run by the processor, causes the processor execute instructions for:

detecting a user input operation, and determining a second client, whose messages are to be deleted, in a target group based on the user input operation; and

sending a delete request to a server, wherein the delete request includes an ID of the target group and an ID of the second client, the server is configured to acquire an ID of a target message based on the delete request and send a delete instruction to a third client, the third client is configured to delete the target message based on the delete instruction, and the delete instruction includes the ID of the target message;

wherein the target message is sent by the second client in the target group, and the first client, the second client, and the third client belong to the target group.

In some embodiments, the message processing program, when run by the processor, causes the processor execute instructions for:

displaying at least one time period option, wherein different time period options correspond to different time periods; and

in response to detecting an operation of selecting any of the at least one time period option, determining a time period corresponding to a selected time period option as a delete time period;

wherein the target message is sent by the second client within the delete time period.

In some embodiments, the delete request further includes a delete time period and an ID of the first client.

In some embodiments, the delete request is intended to instruct the server to:

extract the ID of the first client and the ID of the target group from the delete request;

in response to the ID of the first client and the ID of the target group, determine that the first client has a delete authority, and extract the delete time period from the delete request; and

determine, based on the ID of the second client and the ID of the target group, a message sent by the second client in the target group within the delete time period as the target message, and acquire the ID of the target message.

In some embodiments, the delete instruction indicates an erase-type message event, and the ID of the target message is stored in a content field of the message event; and the delete instruction is broadcast to the third client in the target group.

In some embodiments, the delete request is intended to instruct the server to delete the target message stored in the server.

In some embodiments, the delete request is intended to instruct the server to add a placeholder message at a storage position of the target message; wherein an ID of the placeholder message is the same as the ID of the target message.

According to an embodiment of the present disclosure, a computer-readable storage medium storing a message processing program is further provided. The message processing program, when run by a processor, causes the processor to execute instructions for:

detecting a user input operation, and determining a second client, whose messages are to be deleted, in a target group based on the user input operation; and

sending a delete request to a server, wherein the delete request includes an ID of the target group and an ID of the second client, the server is configured to acquire an ID of a target message based on the delete request and send a delete instruction to a third client, the third client is configured to delete the target message based on the delete instruction, and the delete instruction includes the ID of the target message;

wherein the target message is sent by the second client in the target group, and the first client, the second client, and the third client belong to the target group.

In some embodiments, the message processing program, when run by the processor, causes the processor execute instructions for:

displaying at least one time period option, wherein different time period options correspond to different time periods; and

in response to detecting an operation of selecting any of the at least one time period option, determining a time period corresponding to a selected time period option as a delete time period;

wherein the target message is sent by the second client within the delete time period.

In some embodiments, the delete request further includes a delete time period and an ID of the first client.

In some embodiments, the delete request is intended to instruct the server to:

extract the ID of the first client and the ID of the target group from the delete request;

in response to the ID of the first client and the ID of the target group, determine that the first client has a delete authority, and extract the delete time period from the delete request; and

determine, based on the ID of the second client and the ID of the target group, a message sent by the second client in the target group within the delete time period as the target message, and acquire the ID of the target message.

In some embodiments, the delete instruction indicates an erase-type message event, and the ID of the target message is stored in a content field of the message event; and the delete instruction is broadcast to the third client in the target group.

In some embodiments, the delete request is intended to instruct the server to delete the target message stored in the server.

In some embodiments, the delete request is intended to instruct the server to add a placeholder message at a storage position of the target message; wherein an ID of the placeholder message is the same as the ID of the target message.

According to an embodiment of the present disclosure, a computer program product is further provided. The computer program product includes at least one computer program including at least one instruction. The at least one computer program, when run by a processor, causes the processor to execute instructions for:

detecting a user input operation, and determining a second client, whose messages are to be deleted, in a target group based on the user input operation; and

sending a delete request to a server, wherein the delete request includes an ID of the target group and an ID of the second client, the server is configured to acquire an ID of a target message based on the delete request and send a delete instruction to a third client, the third client is configured to delete the target message based on the delete instruction, and the delete instruction includes the ID of the target message;

wherein the target message is sent by the second client in the target group, and the first client, the second client, and the third client belong to the target group.

In some embodiments, the message processing program, when run by the processor, causes the processor execute instructions for:

displaying at least one time period option, wherein different time period options correspond to different time periods; and

in response to detecting an operation of selecting any of the at least one time period option, determining a time period corresponding to a selected time period option as a delete time period;

wherein the target message is sent by the second client within the delete time period.

In some embodiments, the delete request further includes a delete time period and an ID of the first client.

In some embodiments, the delete request is intended to instruct the server to:

extract the ID of the first client and the ID of the target group from the delete request;

in response to the ID of the first client and the ID of the target group, determine that the first client has a delete authority, and extract the delete time period from the delete request; and

determine, based on the ID of the second client and the ID of the target group, a message sent by the second client in the target group within the delete time period as the target message, and acquire the ID of the target message.

In some embodiments, the delete instruction indicates an erase-type message event, and the ID of the target message is stored in a content field of the message event; and the delete instruction is broadcast to the third client in the target group.

In some embodiments, the delete request is intended to instruct the server to delete the target message stored in the server.

In some embodiments, the delete request is intended to instruct the server to add a placeholder message at a storage position of the target message; wherein an ID of the placeholder message is the same as the ID of the target message.

According to an embodiment of the present disclosure, a server is further provided. The server includes: a processor, a memory, and a message processing program that is stored in the memory and runnable on the processor. The message processing program, when run by the processor, causes the processor execute instructions for:

receiving a delete request from a first client, wherein the delete request is sent by the first client upon determining a second client in a target group, and the second client is determined by the first client based on a detected user input operation;

acquiring an ID of a target message based on the delete request, wherein the target message is sent by the second client in the target group; and

sending a delete instruction to a third client, wherein the third client is configured to delete the target message based on the delete instruction;

wherein the delete request includes an ID of the target group and an ID of the second client, the delete instruction includes the ID of the target message, and the first client, the second client, and the third client belong to the target group.

In some embodiments, the delete request further includes a delete time period and an ID of the first client.

In some embodiments, the delete time period is determined by the first client by:

displaying at least one time period option, wherein different time period options correspond to different time periods; and

in response to detecting an operation of selecting any of the at least one time period option, determining a time period corresponding to a selected time period option as a delete time period;

wherein the target message is sent by the second client within the delete time period.

In some embodiments, the message processing program, when run by the processor, causes the processor to execute instructions for:

extracting the ID of the first client and the ID of the target group from the delete request;

in response to the ID of the first client and the ID of the target group, determining that the first client has a delete authority, and extracting the delete time period from the delete request; and

determining, based on the ID of the second client and the ID of the target group, a message sent by the second client in the target group within the delete time period as the target message, and acquiring the ID of the target message.

In some embodiments, the delete instruction indicates an erase-type message event, and the ID of the target message is stored in a content field of the message event; and

the message processing program, when run by the processor, causes the processor to execute an instruction for: broadcasting the delete instruction the third client in the target group.

In some embodiments, the message processing program, when run by the processor, causes the processor to execute an instruction for: deleting the target message stored in the server.

In some embodiments, the message processing program, when run by the processor, causes the processor to execute an instruction for: adding a placeholder message at a storage position of the target message; wherein an ID of the placeholder message is the same as the ID of the target message.

According to an embodiment of the present disclosure, a computer-readable storage medium storing a message processing program is further provided. The message processing program, when run by a processor, causes the processor to execute instructions for:

receiving a delete request from a first client, wherein the delete request is sent by the first client upon determining a second client, whose messages are to be deleted, in a target group, and the second client is determined by the first client based on a detected user input operation;

acquiring an ID of a target message based on the delete request, wherein the target message is sent by the second client in the target group; and

sending a delete instruction to a third client, wherein the third client is configured to delete the target message based on the delete instruction;

wherein the delete request includes an ID of the target group and an ID of the second client, the delete instruction includes the ID of the target message, and the first client, the second client, and the third client belong to the target group.

In some embodiments, the delete request further includes a delete time period and an ID of the first client.

In some embodiments, the delete time period is determined by the first client by:

displaying at least one time period option, wherein different time period options correspond to different time periods; and

in response to detecting an operation of selecting any of the at least one time period option, determining a time period corresponding to a selected time period option as a delete time period;

wherein the target message is sent by the second client within the delete time period.

In some embodiments, the message processing program, when run by the processor, causes the processor to execute instructions for:

extracting the ID of the first client and the ID of the target group from the delete request;

in response to the ID of the first client and the ID of the target group, determining that the first client has a delete authority, and extracting the delete time period from the delete request; and

determining, based on the ID of the second client and the ID of the target group, a message sent by the second client in the target group within the delete time period as the target message, and acquiring the ID of the target message.

In some embodiments, the delete instruction indicates an erase-type message event, and the ID of the target message is stored in a content field of the message event; and

the message processing program, when run by the processor, causes the processor to execute an instruction for: broadcasting the delete instruction the third client in the target group.

In some embodiments, the message processing program, when run by the processor, causes the processor to execute an instruction for: deleting the target message stored in the server.

In some embodiments, the message processing program, when run by the processor, causes the processor to execute an instruction for: adding a placeholder message at a storage position of the target message; wherein an ID of the placeholder message is the same as the ID of the target message.

According to an embodiment of the present disclosure, a computer program product is further provided. The computer program product includes at least one computer program including at least one instruction. The at least one computer program, when run by a processor, causes the processor to execute instructions for:

receiving a delete request from a first client, wherein the delete request is sent by the first client upon determining a second client in a target group, and the second client is determined by the first client based on a detected user input operation;

acquiring an ID of a target message based on the delete request, wherein the target message is sent by the second client in the target group; and

sending a delete instruction to a third client, wherein the third client is configured to delete the target message based on the delete instruction;

wherein the delete request includes an ID of the target group and an ID of the second client, the delete instruction includes the ID of the target message, and the first client, the second client, and the third client belong to the target group.

In some embodiments, the delete request further includes a delete time period and an ID of the first client.

In some embodiments, the delete time period is determined by the first client by:

displaying at least one time period option, wherein different time period options correspond to different time periods; and

in response to detecting an operation of selecting any of the at least one time period option, determining a time period corresponding to a selected time period option as a delete time period;

wherein the target message is sent by the second client within the delete time period.

In some embodiments, the at least one computer program, when run by the processor, causes the processor to execute instructions for:

extracting the ID of the first client and the ID of the target group from the delete request;

in response to the ID of the first client and the ID of the target group, determining that the first client has a delete authority, and extracting the delete time period from the delete request; and

determining, based on the ID of the second client and the ID of the target group, a message sent by the second client in the target group within the delete time period as the target message, and acquiring the ID of the target message.

In some embodiments, the delete instruction indicates an erase-type message event, and the ID of the target message is stored in a content field of the message event; and

the at least one computer program, when run by the processor, causes the processor to execute an instruction for: broadcasting the delete instruction the third client in the target group.

In some embodiments, the at least one computer program, when run by the processor, causes the processor to execute an instruction for: deleting the target message stored in the server.

In some embodiments, the at least one computer program, when run by the processor, causes the processor to execute an instruction for: adding a placeholder message at a storage position of the target message; wherein an ID of the placeholder message is the same as the ID of the target message.

Each of the embodiments in the specification is described in a progressive fashion, the emphasis of each of the embodiments is put on explaining the difference from other embodiments, and for the same or similar parts of each of the embodiments, cross-reference may be made to these embodiments.

It is easily occurred to those skilled in the art that any combination application of the above embodiments is practical, such that any combination of the above embodiments is practice of the present disclosure, which is not elaborated hereafter one by one due to limitation of space.

The method for processing messages herein is not inherently associated to any particular computer, virtual system or other equipment. In some embodiments, various universal systems may also be used with teachings based on the description herein. It is more apparent to construct a structure required by a system according to a solution of the present disclosure on the basis of the above descriptions. In addition, the present disclosure is also not aimed at any particular programming language. It should be understood that the content described herein of the present disclosure may be realized by various programming languages, and the above description of the particular languages is intended to disclose the preferred embodiments.

Numerous specific details are described in the specification provided herein. However, it should be understood that the embodiments of the present disclosure may be practiced in case of no details. In some examples, well known methods, structures and technologies have not been described in detail as not to obscure understanding of the description.

Similarly, it should be understood, in the above description of the example embodiments of the present disclosure, various features of the present disclosure sometimes are grouped to a single embodiment or figure or its description in order to simplify the present disclosure and help understand one or more various aspects of the present disclosure. However, the method of the present disclosure shall not be interpreted as reflecting an intention that the claimed embodiments require more features than are expressly recited in each claim. More precisely, as reflected in the claims, inventive aspects lie in all features of any single above disclosed embodiment. Therefore, the claims following the detailed descriptions are hereby explicitly incorporated into the detailed descriptions, and each claim itself serves as a separated embodiment of the present disclosure.

Those skilled in the art may understand that the modules in the device in the embodiment may be adaptively changed and set in one or more devices different from the present embodiment. The modules or units or elements in the embodiments may be combined into one module or unit or assembly, and furthermore, these may be divided into a plurality of submodules or subunits or sub-assemblies. Except that at least some of such features and/or processes or units are mutually exclusive, all features disclosed in this specification (including the accompanying claims, abstract, and drawings) and all processes or units of any method or device so disclosed may be combined in any combination. Each feature disclosed in this specification (including the accompanying claims, abstract, and drawings) may be replaced by alternative features serving the same, equivalent or similar purpose, unless expressly stated otherwise.

In addition, while some embodiments described herein include some but not other features included in other embodiments, combinations of features of different embodiments are meant to be within the scope of the present disclosure, and form different embodiments, as would be understood by those skilled in the art. For example, in the claims, any one of the claimed embodiments may be implemented in any combination.

Embodiments of various elements of the present disclosure may be implemented by hardware, or software modules running in one or more processors or a combination thereof. Those skilled in the art shall understand that a microprocessor or a digital signal processor (DSP) may be used in practice to implement some or all functions of some or all elements in the method for processing the message according to an embodiment of the present disclosure. Device or apparatus programs (such as a computer program or a computer program product) for performing a part or all of the methods described herein may also be implemented in the present disclosure. Such program for implementing the present disclosure may be stored in a computer-readable medium or may be in a form having one or more signals. Such signals may be downloaded from Internet sites, or provided on carrier signals, or provided by any other forms.

It should be noted that the above embodiments are for illustrative purposes of the present disclosure, and are not intended to limit the present disclosure, and those skilled in the art may design alternative embodiments without departing from the scope of the appended claims. In the claims, any reference symbol between brackets shall not be constructed as limiting the claims. The words “comprise”, “include” and a variety of derivatives thereof do not exclude the presence of elements or steps which are not listed in the claims. The word “a” or “an” before an element does not exclude the presence of a plurality of such elements. The present disclosure may be implemented by means of hardware including a plurality of different elements and a properly programmed computer. In device claims listing several means, several of these means can be embodied by one and the same item of hardware. Use of the words first, second, third and the like does not indicate any ordering. The words can be interpreted as names.

What is claimed is:

1. A method for processing messages, applicable to a first client, the method comprising:
determining a second client in a target group based on a user input operation, wherein the second client has sent a target message to be deleted in the target group; and
sending a delete request to a server, wherein the delete request comprises an identification (ID) of the target group and an ID of the second client, the server is configured to acquire an ID of the target message based on the delete request and send a delete instruction to a third client, the third client is configured to delete the target message based on the delete instruction, and the delete instruction comprises the ID of the target message;
wherein the first client, the second client, and the third client belong to the target group.

2. The method according to claim 1, further comprising:
displaying at least one time period option, wherein different time period options correspond to different time periods; and
in response to selecting one time period option, determining a time period as a delete time period;
wherein the target message is sent by the second client within the delete time period.

3. The method according to claim 2, wherein the delete request further comprises the delete time period and an ID of the first client.

4. The method according to claim 3, wherein the delete request causes the server to execute following operations:
extracting the ID of the first client and the ID of the target group from the delete request;
extracting the delete time period from the delete request in response to determining that the first client has a delete authority based on the ID of the first client and the ID of the target group;
determining the target message based on the ID of the second client and the ID of the target group, wherein the target message is sent by the second client in the target group within the delete time period; and
acquiring the ID of the target message.

5. The method according to claim 1, wherein: the delete instruction indicates an erase-type message event, and the ID of the target message is stored in a content field of the message event; and the delete instruction is broadcast to the third client in the target group.

6. The method according to claim 1, wherein the delete request causes the server to delete the target message stored in the server.

7. The method according to claim 4, wherein the delete request causes the server to add a placeholder message at a storage position of the target message; wherein an ID of the placeholder message is the same as the ID of the target message.

8. A server, comprising:
a processor; and
a memory storing a message processing program, wherein the message processing program, when run by the processor, causes the processor to perform a method comprising:
receiving a delete request from a first client, wherein the delete request is sent by the first client upon determining a second client, whose messages are to be deleted, in a target group, and the second client is determined by the first client based on a detected user input operation;
acquiring an identification (ID) of a target message based on the delete request, wherein the target message is sent by the second client in the target group; and
sending a delete instruction to a third client, wherein the third client is configured to delete the target message based on the delete instruction;
wherein the delete request comprises an ID of the target group and an ID of the second client, the delete instruction comprises the ID of the target message, and the first client, the second client, and the third client belong to the target group.

9. The server according to claim 8, wherein the delete request further comprises a delete time period and an ID of the first client.

10. The server according to claim 9, wherein the delete time period is determined by the first client by:
displaying at least one time period option, wherein different time period options correspond to different time periods; and
in response to detecting an operation of selecting any of the at least one time period option, determining a time period corresponding to a selected time period option as a delete time period;
wherein the target message is sent by the second client within the delete time period.

11. The server according to claim 9, wherein the method further comprises:
extracting the ID of the first client and the ID of the target group from the delete request;
in response to said extracting the ID of the first client and the ID of the target group, determining that the first client has a delete authority, and extracting the delete time period from the delete request; and
determining, based on the ID of the second client and the ID of the target group, a message sent by the second client in the target group within the delete time period as the target message, and acquiring the ID of the target message.

12. The server according to claim 8, wherein:
the delete instruction indicates an erase-type message event, and the ID of the target message is stored in a content field of the message event; and
the message processing program, when run by the processor, causes the processor to execute an instruction for:
broadcasting the delete instruction to the third client in the target group.

13. The server according to claim 8, wherein the method further comprises:
deleting the target message stored in the server.

14. The server according to claim 8, wherein the method further comprises:
adding a placeholder message at a storage position of the target message;
wherein an ID of the placeholder message is the same as the ID of the target message.

15. A computer-readable storage medium storing a message processing program, wherein the message processing program, when run by a processor, causes the processor to perform a method comprising:
receiving a delete request from a first client, wherein the delete request is sent by the first client upon determining a second client, whose messages are to be deleted, in a target group, and the second client is determined by the first client based on a detected user input operation;
acquiring an identification (ID) of a target message based on the delete request, wherein the target message is sent by the second client in the target group; and
sending a delete instruction to a third client, wherein the third client is configured to delete the target message based on the delete instruction;
wherein the delete request comprises an ID of the target group and an ID of the second client, the delete instruction comprises the ID of the target message, and the first client, the second client, and the third client belong to the target group.

16. The computer-readable storage medium according to claim 15, wherein the delete request further comprises a delete time period and an ID of the first client.

17. The computer-readable storage medium according to claim 16, wherein the method further comprises:
extracting the ID of the first client and the ID of the target group from the delete request;
in response to said extracting the ID of the first client and the ID of the target group, determining that the first client has a delete authority, and extracting the delete time period from the delete request; and
determining, based on the ID of the second client and the ID of the target group, a message sent by the second client in the target group within the delete time period as the target message, and acquiring the ID of the target message.

18. The computer-readable storage medium according to claim 15, wherein:
the delete instruction indicates an erase-type message event, and the ID of the target message is stored in a content field of the message event; and
the message processing program, when run by the processor, causes the processor to execute an instruction for:
broadcasting the delete instruction to the third client in the target group.

19. The computer-readable storage medium according to claim 15, wherein the method further comprises:
deleting the target message stored in the computer-readable storage medium.

20. The computer-readable storage medium according to claim 15, wherein the method further comprises:
adding a placeholder message at a storage position of the target message;
wherein an ID of the placeholder message is the same as the ID of the target message.
